(19) United States
(12) Patent Application Publication
(10) Pub. No.: US 2006/0138199 A1
(43) Pub. Date: Jun. 29, 2006

(54) Welding method for manufacturing a golf club head

(75) Inventor: Chan-Tung Chen, Kaohsiung (TW)

Correspondence Address: BIRCH STEWART KOLASCH & BIRCH, PO BOX 747, FALLS CHURCH, VA, 22040-0747, US

(73) Assignee: NELSON PRECISION CASTING CO., LTD.

(21) Appl. No.: 11/022,772

(22) Filed: Dec. 28, 2004

(51) Int. Cl. B23K 20/12

(52) U.S. Cl. 228/115; 228/3.1

(57) ABSTRACT

A welding method for manufacturing the golf club head includes the steps of: prefabricating a first club head member having a first welding surface, and a second club head member having a second welding surface; aligning the first welding surface of the first club head member with the second welding surface of the second club head member; welding the first welding surface of the first club head member to the second welding surface of the second club head member to form a welding portion by means of magnetic pulse welding; and surface finishing the first club head member, the second club head member and the welding portion to finish a product of the golf club head.

### BACKGROUND OF THE INVENTION

1. Field of the Invention

The present invention relates to a welding method for manufacturing a golf club head. More particularly, the present invention relates to a magnetic pulse welding (MPW) method for manufacturing the golf club head that improves welding compatibility of heterogeneous welding for different metals and welding strength of welded portions.

2. Description of the Related Art

Currently, golf club heads are widely designed in manufacturing by composite materials. Particularly, a club head body and a striking plate are separately made of different metals and then assembled to constitute the golf club head. For example, the club head body is made of 17-4PH steel and the striking plate is made of 6Al-4V titanium alloy. Accordingly, the club head body can provide with not only strong construction of the club head body but also highly resilient deformation of the striking plate.

However, the composite metals can improve striking ability of the golf club head. In manufacture, it is difficult to joint two or more golf club head members (fragments) made of different metals and thus to perform excellent strength of the composite metals. Typically, the golf club head industry adopts manufacture methods of snapping, adhering, braze welding and gas tungsten arc welding (GTAW) in combining the striking plate with the club head body.

In regard to snapping method, a clearance may be remained between boundaries of the club head body and the striking plate. This clearance can cause failure of the golf club head in transmitting a striking stress, and result in degradation of the resilient deformation of the striking plate while striking golf ball. Moreover, noises are generated from the clearance by the striking plate knocking on the club head body.

In regard to adhering method, joints of the golf club head members perform poor strength so that scopes of applications are narrowed in the golf club head industry.

In regard to braze welding method, joints of the golf club head members also perform poor strength so that scopes of applications are narrowed in the golf club head industry

In regard to gas tungsten arc welding method, welding compatibility of heterogeneous welding for two different metals is generally poor that results in cooling crack, thermal cracking of a welded portion and degradation of mechanical properties. Consequently, it cannot effectively improve yield of the golf club head.

In order to solve the above problem, solid-state welding has been developed in improving the welding quality in the golf club head industry. Friction stir welding is one method of improving the welding quality.

U.S. Patent Application Publication No. 2002/0187851 discloses a manufacture method for welding a golf club head. The golf club head commonly includes a club head body and a striking plate. The club head body is made of a first metal material, such as steel. The striking plate is made of a second metal material, such as titanium alloy, and formed with a circular outer periphery. In assembling, the striking plate mechanically connects to the club head body by means of friction welding. A pressing force (P) is applied on the striking plate which is tightly abutted against a sweet spot region of the club head body. Subsequently, the striking plate is spun on the sweet spot region of the club head body with a highly rotational speed ranging from 2,000 rpm to 3,000 rpm. After that, connected between the striking plate and the club head body is a solid-state welded portion due to friction. Consequently, the striking plate rapidly connects to the club head body. In the final manufacture step, a club head product is appropriately made in deburring of the striking plate and surface finishing on the club head body.

In comparison with other connecting method, the friction welding method applied to the golf club head is relatively effective in simplifying the manufacture process and improving the welding quality. However, the friction welding method has several drawbacks. First, modification of a club head member requires a circular outer periphery that permits a rotational movement of the club head member about the club head body. Contrarily, the club head member with a non-circular outer periphery is unsuitable for processing the friction welding. Second, generated between the striking plate and the club head body is a brittleness intermetallic layer or a hardened metal layer if metals of the striking plate and the club head body have poor welding compatibility. In particular, the brittleness intermetallic layer is disadvantageous in improving combination strength of the golf club head when the striking plate and the club head body are made of metals with poor welding compatibility. Thus, it results in cracks of the construction or degradation in resilient deformation while striking golf ball.

Hence, there is a need for a welding method for welding the golf club head and for improving welding quality thereof. To accomplish this task, it is necessary that welding portions of club head members of the golf club head must be modified.

The present invention intends to provide a welding method for welding two golf club head members of a golf club head body and pre-fabricating a welding surface on each of the golf club head members. The welding surfaces of the club head members are correspondingly connected and welded in magnetic pulse welding. Thereby, the magnetic pulse welding can improve welding compatibility of heterogeneous welding and intensify welding strength of the golf club head in such a way to mitigate and overcome the above problem.

### SUMMARY OF THE INVENTION

The primary objective of this invention is to provide a welding method for welding two golf club head members by employing magnetic pulse welding. Thereby, the magnetic pulse welding can speed up the welding process in manufacturing the golf club head.

The secondary objective of this invention is to provide the welding method for welding two golf club head members by employing magnetic pulse welding. Thereby, the magnetic pulse welding can improve welding compatibility of heterogeneous welding and intensify welding strength of the golf club head.

The welding method for the golf club head in accordance with the present invention includes the steps of: prefabricating a first club head member having a first welding surface, and a second club head member having a second welding surface; aligning the first welding surface of the first club head member with the second welding surface of the second club head member; welding the first welding surface of the first club head member to the second welding surface of the second club head member to form a welding portion by means of magnetic pulse welding; and surface finishing the first club head member, the second club head member and the welding portion to finish a product of the golf club head.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given which are given by way of illustration only, and thus are not limitative of the present invention, and wherein:

FIG. 1 is a block diagram of a welding method for manufacturing a golf club head in accordance with the present invention;

FIG. 2 is an exploded cross-sectional view of processing the golf club head in a welding step in accordance with a first embodiment of the present invention;

FIG. 2A is an enlarged view, in FIG. 2, of processing the golf club head in the welding step in accordance with the first embodiment of the present invention;

FIG. 3 is a cross-sectional view of the golf club head after processing the welding step in accordance with the first embodiment of the present invention;

FIG. 3A is a micrograph view, in FIG. 3, of a welding portion of the golf club head after processing the welding step in accordance with the first embodiment of the present invention;

FIG. 4 is a perspective view of the golf club head after processing the welding step in accordance with the first embodiment of the present invention;

FIG. 5 is an exploded cross-sectional view of processing the golf club head in the welding step in accordance with a second embodiment of the present invention;

FIG. 6 is an exploded cross-sectional view of processing the golf club head in the welding step in accordance with a third embodiment of the present invention;

FIG. 6A is an enlarged view, in FIG. 6, of processing the golf club head in the welding step in accordance with the third embodiment of the present invention;

FIG. 7 is a cross-sectional view of the golf club head after processing the welding step in accordance with the third embodiment of the present invention;

FIG. 8 is an exploded cross-sectional view of processing the golf club head in the welding step in accordance with a fourth embodiment of the present invention;

FIG. 9 is an exploded cross-sectional view of processing the golf club head in the welding step in accordance with a fifth embodiment of the present invention;

FIG. 10 is a cross-sectional view of the golf club head after processing the welding step in accordance with the fifth embodiment of the present invention;

FIG. 11 is a perspective view of the golf club head after processing the welding step in accordance with the fifth embodiment of the present invention; and

FIG. 12 is an exploded cross-sectional view of processing the golf club head in the welding step in accordance with a sixth embodiment of the present invention.

### DETAILED DESCRIPTION OF THE INVENTION

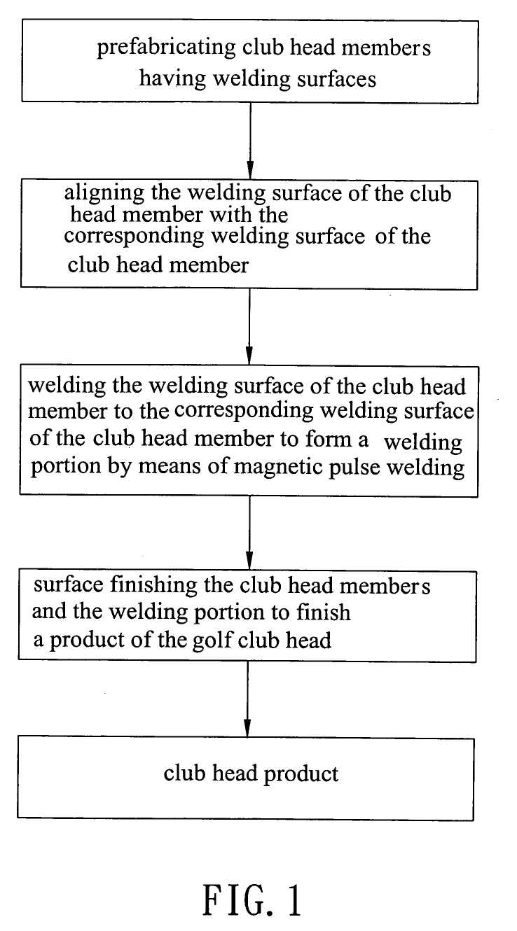

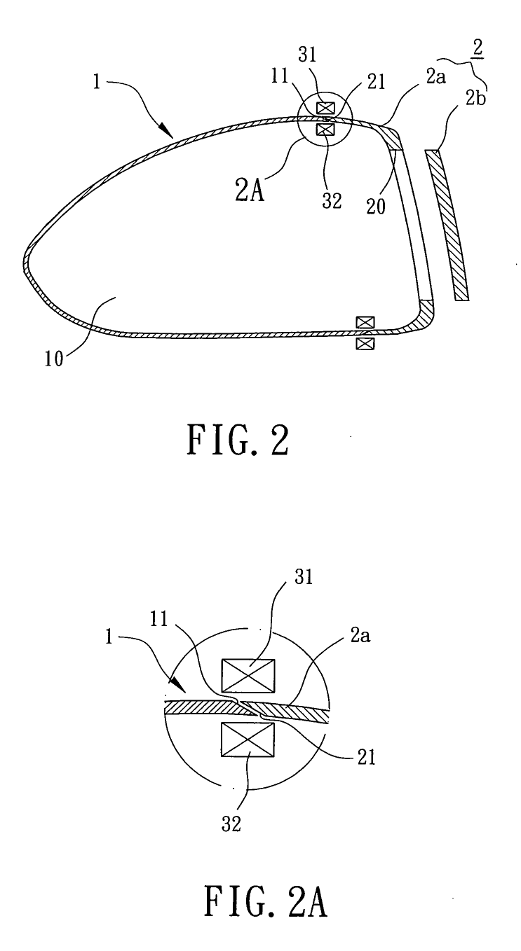

Referring initially to FIGS. 1 and 2, a welding method in accordance with the present invention is applied to a golf club head. The golf club head generally includes a golf club head body regarded as a first golf club head member designated numeral 1, and a striking plate regarded as a second golf club head member designated numeral 2.

Still referring to FIGS. 1 and 2, the welding method in accordance with a first embodiment of the present invention includes a first step that prefabricates a first welding surface 11 of the first golf club head member 1 and a second welding surface 21 of the second golf club head member 2. In the beginning, the first golf club head member 1 and the second golf club head member 2 are fabricated by methods selected from a group consisting of precision casting, forging and mechanically finishing. The first golf club head member 1 and the second golf club head member 2 constitute a wood type club head made of a single metal material or composite materials selected from a group consisting of steel (such as 17-4H steel), carbon steel, low-carbon steel, alloy steel, low alloy steel, Fe—Mn—Al alloy, cast iron, nickel alloy, structural steel, super alloy steel, tungsten alloy and titanium alloy (6Al-4V titanium alloy).

Referring again to FIG. 2, the construction of the first golf club head member 1 shall be described in detailed. The first golf club head member 1 includes at least one interior compartment 10 which has an opening at its front side. The first welding surface 11 is provided on an outer surface of the first golf club head member 1 proximate to a periphery of the opening of the interior compartment 10. Preferably, the first welding surface 11 is located on an end surface, and further inclined on the outer surface to the front side of the first golf club head member 1 so as to increase a connecting area thereof.

Referring again to FIG. 2, the construction of the second golf club head member 2 shall be described in detail. The second golf club head member 2 consists of an annular wall 2a and a face wall 2b to constitute the striking plate. The annular wall 2a provides with an assembling hole 20 spaced apart from the second welding surface 21. Preferably, the face wall 2b connects to the annular wall 2a by means of welding, such as laser welding or high-energy beam welding. The second welding surface 21 is provided and inclined on an inner surface of the annular wall 2a which is located at its rear side. Preferably, an inclined surface of the second welding surface 21 is corresponding to that of the first welding surface 11.

Referring to FIGS. 1, 2 and 2A, the welding method in accordance with the present invention includes a second step that aligns the first welding surface 11 of the first club head member 1 with the second welding surface 21 of the second club head member 2. Spaced between the first welding surface 11 of the first club head member 1 and the second welding surface 21 of the second club head member 2 is a predetermined slight distance so that the first welding surface 11 disconnects with the second welding surface 21. In consideration of permitting a welding process through the opening of the annular wall 2a, the annular wall 2a and the face wall 2b are disassembled prior to welding operation.

Referring to FIGS. 1, 2, 2A, 3 and 3A, the welding method in accordance with the present invention includes a third step that welds the first welding surface 11 of the first club head member 1 to the second welding surface 21 of the second club head member 2 to form a welding portion 41 by means of magnetic pulse welding (MPW). The magnetic pulse welding method is one method of solid-state welding which performs excellent welding compatibility of heterogeneous welding for different metals, and minimizes a heat effective zone for welding. The present invention employs a pair of magnetic pulse apparatuses 31, 32 between which to locate the first welding surface 11 and the second welding surface 21. Each of the magnetic pulse apparatuses 31, 32 consists of a magnet-exciting coil to generate a high-energy pulse current by periodically discharging a capacitor. Consequently, the magnetic pulse apparatuses 31, 32 are operated to cause eddy currents on the first club head member 1 and the second club head member 2. Each eddy current of the first club head member 1 and the second club head member 2 creates a magnetic field and a repulsive magnetic force thereof. The two magnetic fields of the first club head member 1 and the second club head member 2 are repulsed each other so that each of the first club head member 1 and the second club head member 2 is correspondingly moved away from each of the magnetic pulse apparatuses 31, 32 in high speed. Namely, there is a great magnetic pressure between the first club head member 1 and the second club head member 2. Therefore, the first welding surface 11 of the first club head member 1 abuts against the second welding surface 21 of the second club head member 2 until metal strength of the first club head member 1 and the second club head member 2 is greater than yield strength for permitting plastic deformation of the metal. The repulsive magnetic force is inversed-proportional to the square of the discharged high-energy pulse current. In operation of magnetic pulse welding, the high-energy pulse current can be adjusted for controlling strength of the repulsive magnetic force so as to cause plastic deformation when adopting different metals.

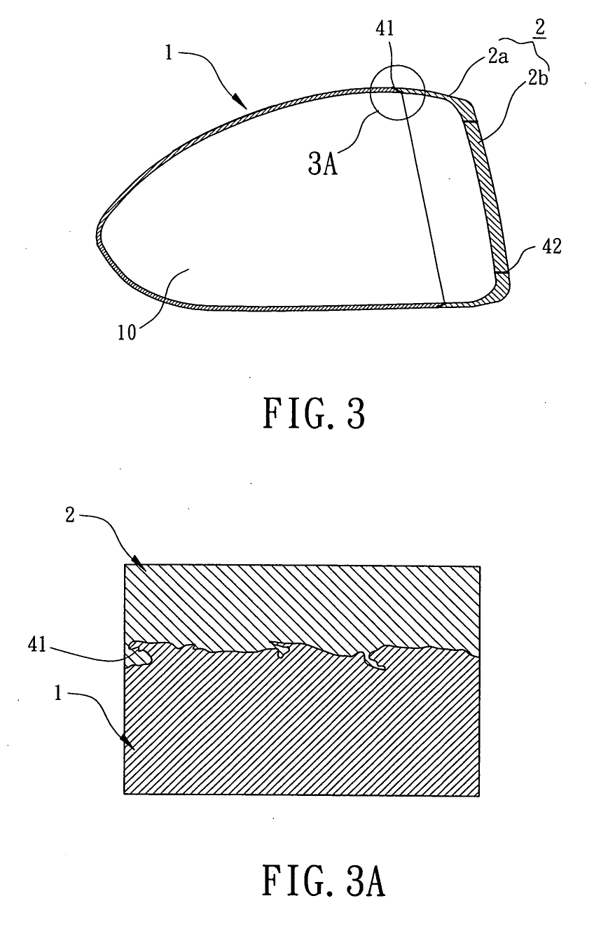

Referring again to FIG. 3, the first welding surface 11 of the first club head member 1 is welded to the second welding surface 21 of the second club head member 2 to form the welding portion 41 after the magnetic pulse welding. FIG. 3A illustrates the welding portion 41 formed between the first welding surface 11 of the first club head member 1 and the second welding surface 21 of the second club head member 2 in the magnetic pulse welding. Connected between the first welding surface 11 and the second welding surface 21 is a joint boundary of the welding portion 41 with a wavy plastic deformation. The welding portion 41 performs excellent welding compatibility of heterogeneous welding for different metals that increase combination strength of the first club head member 1 with the second club head member 2. Subsequently, the magnetic pulse apparatus 32 can be removed from the assembling hole 20 of the annular wall 2a after forming the welding portion 41. Next, the face wall 2b mechanically connects to the assembling hole 20 of the annular wall 2a to seal the golf club head by ordinary welding. Consequently, an annular welding portion 42 connects between the face wall 2a and the annular wall 2b.

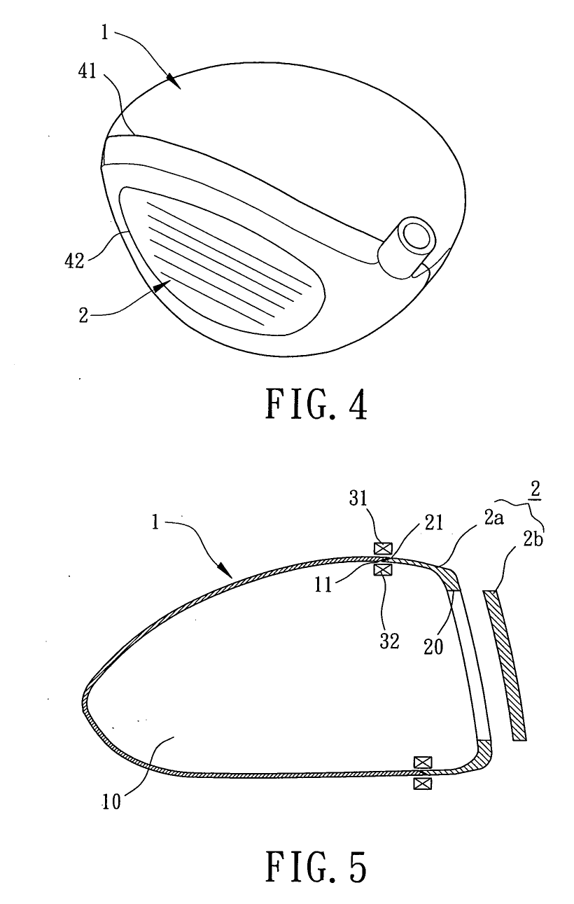

Referring to FIGS. 1, 2, 3 and 4, the welding method in accordance with the present invention includes a fourth step that finishes surfaces of the first club head member 1, the second club head member 2 and the welding portion 41 to make a product of the golf club head. The first club head member 1, the annular wall 2a and the face wall 2b of the second club head member 2 are assembled to form a semifinished product of the golf club head subsequent to the welding operation.

Referring back to FIG. 3, the combination of the annular wall 2a with the face wall 2b of the second club head member 2 has a U or V shaped cross-sectional section of the striking plate which permits a preferred resilient deformation while striking golf ball. Finally, the surface of the golf club head is processed by deburring, removal of residual material, derusting, hosel's angle adjusting, electroplating, ionized evaporation plating, coating, mirror finishing, satin finishing, mechanical or laser engraving, shot peening, pattern/trademark printing, protective painting or protective film bonding. Thereby, the appearances of the finished products of the golf club heads are identical.

Turning now to FIG. 5, reference numerals of the second embodiment of the present invention have applied the identical numerals of the first embodiment, as shown in FIG. 2. The construction of the golf club head structure in accordance with the second embodiment of the present invention has similar configuration and same function as that of the golf club head structure of the first embodiment and detailed descriptions may be omitted.

Still referring to FIG. 5, in comparison with the first embodiment, the first welding surface 11 of the second embodiment is provided on an inner surface of the first golf club head member 1 proximate to a periphery of the opening of the interior compartment 10. Preferably, the first welding surface 11 is inclined on the inner surface to front side the first golf club head member 1. An inclined surface of the second welding surface 21 is located on an inner surface and corresponding to that of the first welding surface 11. Located between the magnetic pulse apparatuses 31, 32 are the first welding surface 11 and the second welding surface 21. The two magnetic fields of the first club head member 1 and the second club head member 2 are repulsed each other so that the first welding surface 11 of the first club head member 1 abuts effectively against the second welding surface 21 of the second club head member 2. Consequently, a gap between the first welding surface 11 and the second welding surface 21 inclines to a common actuating direction of the magnetic pulse apparatuses 31, 32 that insures assembling efficiency and welding strength of the magnetic pulse welding.

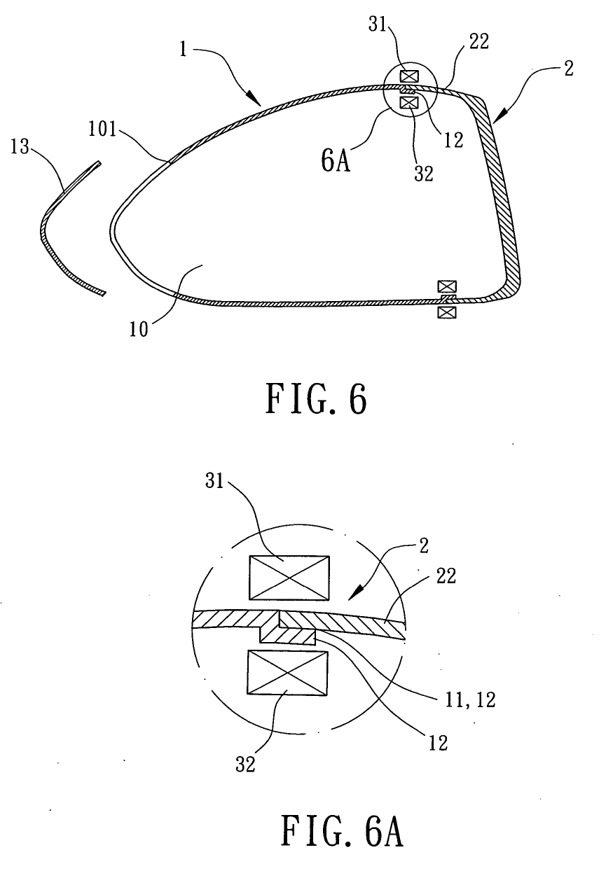

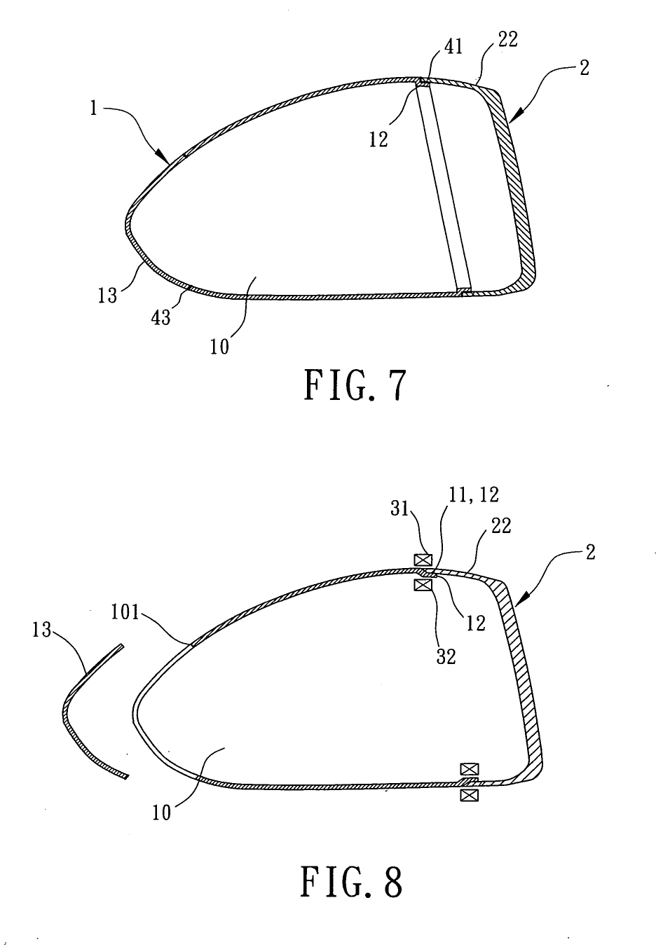

Turning now to FIGS. 6, 6A and 7, reference numerals of the third embodiment of the present invention have applied the identical numerals of the first embodiment, as shown in FIG. 2. The construction of the golf club head structure in accordance with the third embodiment of the present invention has similar configuration and same function as that of the golf club head structure of the first embodiment and detailed descriptions may be omitted.

Referring again to FIGS. 6, 6A and 7, in comparison with the first embodiment, the first club head member 1 of the third embodiment provides with a stepped portion 12 at the opening of the interior compartment 10. The first welding surface 11 is located on the outer surface of the first club head member 1. The first club head member 1 further provides with an operation hole 101 in communication with a rear side of the interior compartment 10. A rear cover 13 is welded to the operation hole 101 for sealing the interior compartment 10 of the first club head member 1. In consideration of permitting a welding process through the operation hole 101 of the first club head member 1, the first club head member 1 and the rear cover 13 are disassembled prior to welding operation. Furthermore, the second club head member 2 is integrally formed an annular upright wall 22 so that the second welding surface 21 is provided on an inner surface of the second club head member 2. In welding operation, the magnetic pulse apparatuses 31, 32 is operated to weld the first welding surface 11 to the second welding surface 21 to form the welding portion 41. Next, the rear cover 13 mechanically connects to the operation hole 101 of the first club head member 1 to seal the golf club head by high-energy beam welding or gas tungsten arc welding. Consequently, an annular welding portion 43 connects between the first club head member 1 and the rear cover 13.

Turning now to FIG. 8, reference numerals of the fourth embodiment of the present invention have applied the identical numerals of the third embodiment, as shown in FIG. 6. The construction of the golf club head structure in accordance with the fourth embodiment of the present invention has similar configuration and same function as that of the golf club head structure of the third embodiment and detailed descriptions may be omitted.

Referring again to FIG. 8, in comparison with the third embodiment, the first welding surface 11 of the first golf club head member 1 and the second welding surface 21 of the second golf club head member 2 of the fourth embodiment are correspondingly inclined. Located between the magnetic pulse apparatuses 31, 32 are the first welding surface 11 and the second welding surface 21. The two magnetic fields of the first club head member 1 and the second club head member 2 are repulsed each other. Consequently, a gap between the first welding surface 11 and the second welding surface 21 inclines to a common actuating direction of the magnetic pulse apparatuses 31, 32 that insures assembling efficiency and welding strength of the magnetic pulse welding.

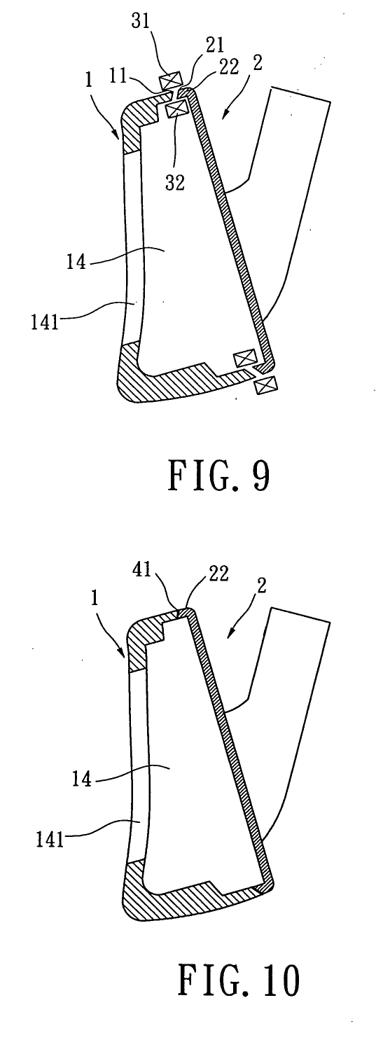

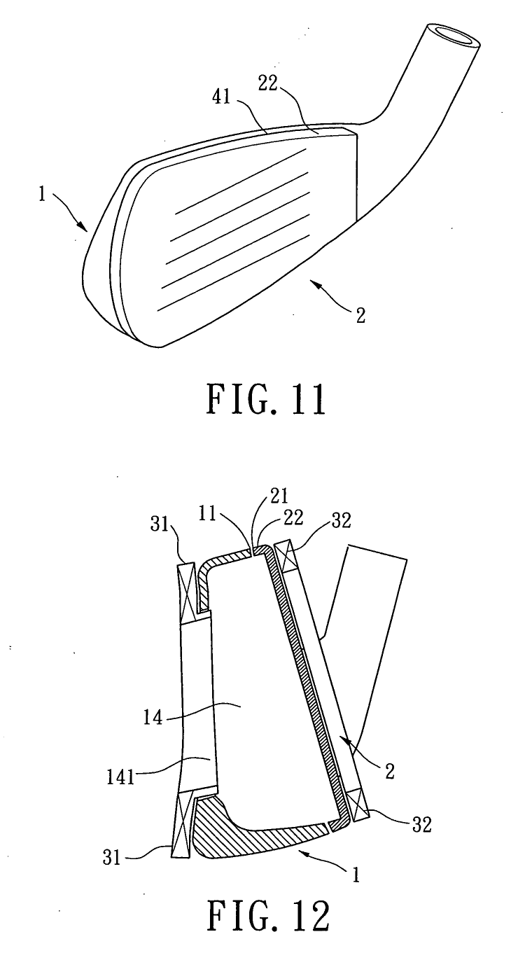

Turning now to FIGS. 9, 10 and 11, reference numerals of the fifth embodiment of the present invention have applied the identical numerals of the first embodiment, as shown in FIG. 2. The construction of the golf club head structure in accordance with the fifth embodiment of the present invention has similar configuration and same function as that of the golf club head structure of the first embodiment and detailed descriptions may be omitted.

Referring again to FIGS. 9, 10 and 11, in comparison with the first embodiment, the golf club head of the fifth embodiment is an iron type golf club head. The first club head member 1 provides with a recession 14 at its front side. The first welding surface 11 is located on the outer surface of the first club head member 1. The first club head member 1 further provides with an operation hole 141 at its rear side for permitting a welding process through the operation hole 141. Furthermore, the second club head member 2 is integrally formed the annular upright wall 22 so that the second welding surface 21 is provided on an inner surface of the second club head member 2. The first welding surface 11 of the first golf club head member 1 and the second welding surface 21 of the second golf club head member 2 are correspondingly inclined. In welding operation, the magnetic pulse apparatuses 31, 32 weld the first welding surface 11 to the second welding surface 21 to form the welding portion 41.

Turning now to FIG. 12, reference numerals of the sixth embodiment of the present invention have applied the identical numerals of the fifth embodiment, as shown in FIG. 9. The construction of the golf club head structure in accordance with the fourth embodiment of the present invention has similar configuration and same function as that of the golf club head structure of the fifth embodiment and detailed descriptions may be omitted.

Referring again to FIG. 12, in comparison with the fifth embodiment, the first welding surface 11 of the first golf club head member 1 and the second welding surface 21 of the second golf club head member 2 of the sixth embodiment are annular flat surfaces. A gap between the first welding surface 11 and the second welding surface 21 is substantially perpendicular to a common actuating direction of the magnetic pulse apparatuses 31, 32 that insures assembling efficiency and welding strength of the magnetic pulse welding.

As has been described, the conventional golf club head adopts manufacture methods of snapping, adhering, braze welding and gas tungsten arc welding (GTAW) in combining the striking plate with the club head body. Referring back to FIGS. 1 and 2, the first club head member 1 and the second club head member 2 provide with the first welding surface 11 and the second welding surface 21 which are welded to form the welding portion 41 by the magnetic pulse apparatuses 31, 32 for magnetic pulse welding.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A welding method for manufacturing a golf club head comprising the steps of:
prefabricating a first club head member having a first welding surface, and a second club head member having a second welding surface;
aligning the first welding surface of the first club head member with the second welding surface of the second club head member; and
welding the first welding surface of the first club head member to the second welding surface of the second club head member to form a welding portion by means of magnetic pulse welding to constitute the golf club head.

2. The welding method for manufacturing the golf club head as defined in claim 1, wherein the first club head member is a golf club head body including at least one interior compartment and an opening thereof, and the opening is located at a front side of the interior compartment.

3. The welding method for manufacturing the golf club head as defined in claim 1, wherein the second golf club head member is a striking plate and consists of an annular wall portion and a face portion, and the second welding surface is provided on an inner surface of the annular wall which further provides with an assembling hole to assemble the face wall.

4. The welding method for manufacturing the golf club head as defined in claim 1, wherein the first welding surface and the second welding surface are correspondingly inclined.

5. The welding method for manufacturing the golf club head as defined in claim 1, wherein the first club head member is a golf club head body including at least one interior compartment and an opening thereof, and the golf club head body provides with a stepped portion at the opening of the interior compartment.

6. The welding method for manufacturing the golf club head as defined in claim 5, wherein the golf club head body further provides with an operation hole in communication with a rear side of the interior compartment, and the operation hole connects with a rear cover.

7. The welding method for manufacturing the golf club head as defined in claim 1, wherein the second club head member is a striking plate integrally formed an annular upright wall so that the second welding surface is provided on an inner surface of the striking plate.

8. The welding method for manufacturing the golf club head as defined in claim 1, wherein the first club head member is a golf club head body provided with a recession at a front side so that the first welding surface is located on an outer surface of the golf club head body.

9. The welding method for manufacturing the golf club head as defined in claim 1, wherein the second club head member is a striking plate integrally formed an annular upright wall so that the second welding surface is provided on an end surface of the striking plate.

10. The welding method for manufacturing the golf club head as defined in claim 1, wherein the first club head member and the second club head member are made of heterogeneous metal or alloy.
